(19) United States
(12) Patent Application Publication
(10) Pub. No.: US 2004/0003981 A1
(43) Pub. Date: Jan. 8, 2004

(54) Apparatus and method for recognizing currency

(75) Inventor: Charng-Long Lee, Hsinchu City (TW)

Correspondence Address: BACON & THOMAS, PLLC, 625 SLATERS LANE, FOURTH FLOOR, ALEXANDRIA, VA, 22314

(73) Assignees: Sunplus Technology Co., Ltd., Hsin-Chu (TW); D-Link Corporation, Hsinchu (TW)

(21) Appl. No.: 10/445,841

(22) Filed: May 28, 2003

(30) Foreign Application Priority Data
Jul. 5, 2002 (TW) 91114935

(51) Int. Cl. G07D 5/00

(52) U.S. Cl. 194/328

(57) ABSTRACT

An apparatus and method used in a money-receiving machine for recognizing currency is disclosed. After a coin or a paper currency inserted into a coin or paper currency receiving unit of the money-receiving machine, the currency recognition apparatus fetches an image of the inserted currency, and selects the reference image of currency corresponding to the image of the inserted currency from a database. Then the currency recognition apparatus calculates a similarity value between the image of the inserted currency and the reference image of the selected currency, and determines that the inserted is genuine if the similarity value is larger than a critical value.

### BACKGROUND OF THE INVENTION

1. Field of the Invention

The present invention relates to the technical field of currency recognizing and, more particularly, to an apparatus and a method for recognizing coins or paper currency.

2. Description of Related Art

Conventionally, an apparatus for recognizing currency, for example a coin, is implemented in a vending machine or currency exchanger. Such an apparatus compares the shape, weight, physical property, material, thickness, resistance, and/or magnetic property an inserted coin with that of a genuine coin, so as to determine whether the inserted coin is genuine or not, and determine the type of the coin.

However, the conventional apparatus suffers from a disadvantage as detailed below. It is understood that there are a variety of statutory coins issued by governments all over the world. Also, many amusement parks issue their own coins in which some of them are very similar to that issued by the government in respect of the shape, weight, physical property, material, etc. As such, the function of apparatus for recognizing coin may misjudge those similar coins inserted into the vending machine or currency exchanger as genuine statutory coins since the apparatus cannot recognize their differences. Thus, the owner of the vending machine or currency exchanger may suffer loss if a thief uses counterfeit coins in operating the machine.

Therefore, it is desirable to provide a novel apparatus and method for recognizing currency including coins and paper currency to mitigate and/or obviate the aforementioned problems.

### SUMMARY OF THE INVENTION

An object of the present invention is to provide an apparatus and method for recognizing currency to improve accuracy and reject counterfeit currency by fetching image characteristics of currency inserted in a money-receiving device to compare with images of genuine currency.

Another object of the present invention is to provide an apparatus and method for recognizing currency wherein the number and shape of reference images of coins or paper currencies stored in a database may be updated based on the genuine currency.

One aspect of the present invention is to provide a coin recognition apparatus mounted in a money-receiving machine. The money-receiving machine has a distributor and a coin receiving unit adapted for receiving and positioning an inserted coin to be recognized. The coin recognition apparatus comprises: a database for storing a plurality of reference images including head and tail images of coins; an image sensor disposed at a side of the coin receiving unit for fetching an image of the inserted coin; and an image recognition unit for comparing the image of the inserted coin with the reference images from the database to generate a determination result for controlling the distributor to accept or reject the inserted coin.

Another aspect of the present invention is to provide a paper currency recognition apparatus mounted in a money-receiving machine. The money-receiving machine has a distributor and a paper currency receiving unit adapted for receiving and positioning an inserted paper currency. The paper currency recognition apparatus comprises: a database for storing a plurality of reference images including front and back images of paper currencies; an image sensor disposed at a side of the paper currency receiving unit for fetching an image of the inserted paper currency; and, an image recognition unit for comparing the image of the inserted paper currency with the reference images of paper currencies from the database to generate a determination result for controlling the distributor to accept or reject the inserted paper currency.

Still another aspect of the present invention is to provide a coin recognition method used in a coin recognition apparatus mounted in a money-receiving machine for recognizing an inserted coin. The money-receiving machine has a distributor and a coin receiving unit for receiving and positioning the inserted coin. The coin recognition apparatus has a database, an image sensor, and an image recognition unit. The coin recognition method comprises the steps of: (a) fetching an image of the inserted coin by the image sensor; (b) selecting the reference image of coin corresponding to the image of the inserted coin from the database based on the contour of the image of the inserted coin by the image recognition unit; (c) calculating a similarity value between the image of the inserted coin and the selected reference image; comparing the similarity value with a critical value to determine whether the similarity value is larger than a critical value, and if yes, determining that the inserted coin is genuine, otherwise performing step (d); and (d) rotating the image of the inserted coin by a predetermined angle; determining whether the rotated angle is larger than 360 degrees, and if yes, determining that the inserted coin is counterfeit, otherwise performing step (c).

A further aspect of the present invention is to provide a paper currency recognition method used in a paper currency recognition apparatus mounted in a money-receiving machine for recognizing an inserted paper currency. The money-receiving machine has a distributor and a coin receiving unit for receiving and positioning the inserted paper currency. The paper currency recognition apparatus has a database, an image sensor, and an image recognition unit. The paper currency recognition method comprises the steps of: (a) fetching an image of the inserted paper currency by the image sensor; (b) selecting the reference image of paper currency corresponding to the image of the inserted paper currency from the database based on a character shown on the image of the inserted paper currency by the image recognition unit; (c) calculating a similarity value between the image of the inserted paper currency and the reference image of paper currency; comparing the similarity value with a critical value for determining whether the similarity value is larger than a critical value, and if yes, determining that the inserted paper currency is genuine, otherwise performing step (d); and (d) rotating the inserted paper currency by an angle of 180 degrees; calculating a similarity value between the rotated image of the inserted paper currency and the reference image of paper currency; comparing the similarity value with the critical value for determining whether the similarity value is larger than a critical value, and if yes, determining that the inserted paper currency is genuine, otherwise determining that the inserted paper currency is counterfeit.

Other objects, advantages, and novel features of the invention will become more apparent from the detailed description when taken in conjunction with the accompanying drawings.

### BRIEF DESCRIPTION OF THE DRAWINGS

FIG. 1 is a functional block diagram of a first preferred embodiment of a coin recognition apparatus according to the present invention;

FIG. 2 is a flow chart illustrating a process of recognizing the coin;

FIG. 3 is a functional block diagram of a second preferred embodiment of a paper currency recognition apparatus according to the present invention; and

FIG. 4 is a flow chart illustrating a process of recognizing the paper currency.

### DETAILED DESCRIPTION OF THE PREFERRED EMBODIMENT

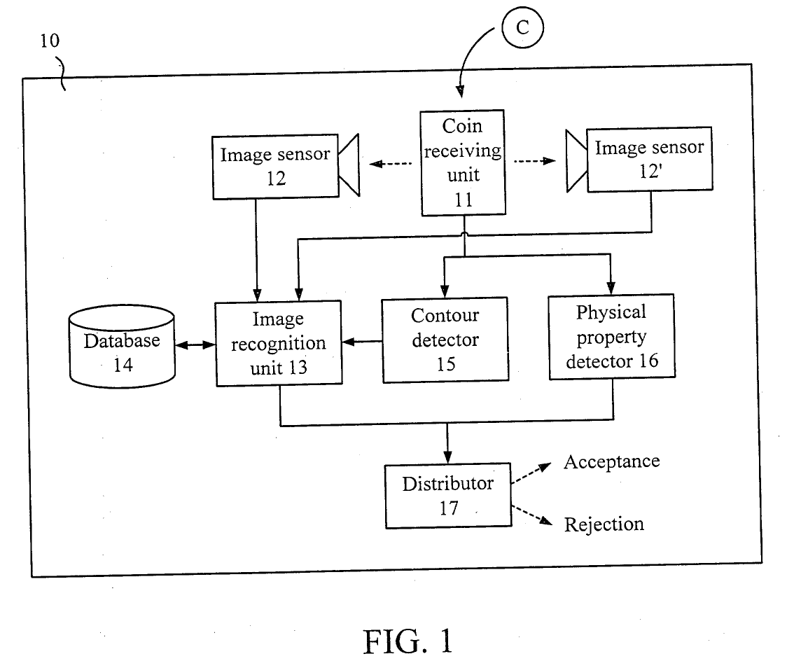

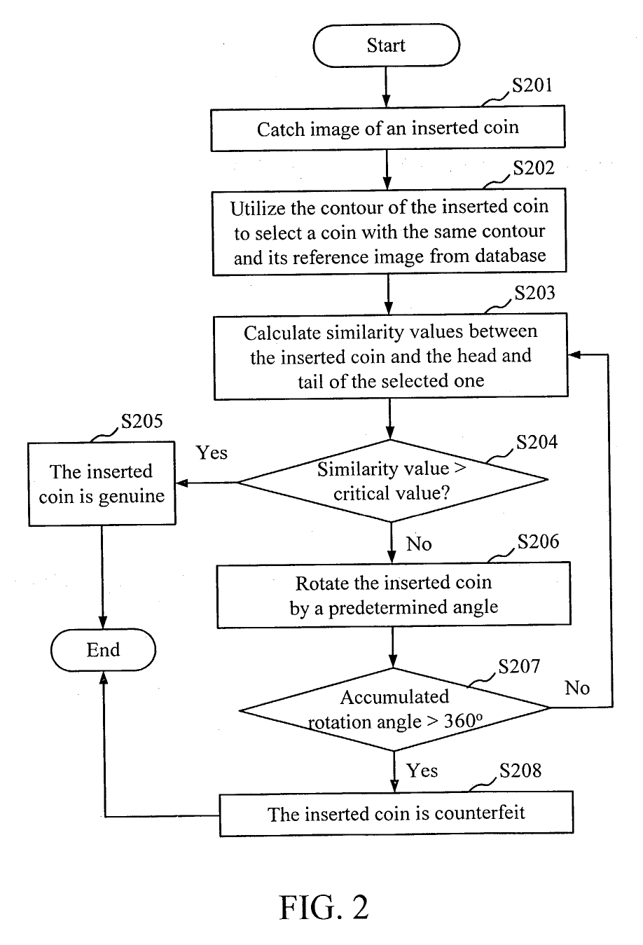

With reference to FIGS. 1 and 2, there is shown a first preferred embodiment of coin recognition apparatus mounted in a money-receiving machine 10 and a process of recognizing a coin in accordance with the invention respectively. The money-receiving machine 10 is installed in a vending machine, currency exchanger, or the like for coin recognition.

Components of the money-receiving machine 10 and associated flow steps are detailed below. The coin receiving unit 11 can receive an inserted coin C. The inserted coin C is positioned in the coin receiving unit 11 with a side thereof facing an image sensor 12 disposed at a side of the coin receiving unit 111. As such, the image sensor 12 may catch an image of one side of the inserted coin C (step S201). Preferably, the image sensor 12 is a camera mounted with a light source device, such as a flashlight. Thus, light can be cast on the side of coin for obtaining a clear image thereof as the image sensor 12 is activated.

Because there are a variety of statutory coins, and one coin may have a different shape, weight, stamped pattern, or physical property from the other, the image recognition unit 13 may first utilize the contour of the inserted coin C to select a coin with the same contour and its reference image from a database 14 pre-stored with a plurality of reference images (step S202). Hence, other initially unmatched images of coins are not considered for subsequent matching step, and image comparisons of both head and tail of only the selected reference image with that of the inserted coin C are required. This can significantly reduce workload of the coin recognition apparatus. Further, a contour detector 15 may also be employed to fetch a contour of the inserted coin C. The image recognition unit 13 may utilize the fetched contour of the inserted coin C to find a matched reference image from the database 14.

Next, the image recognition unit 13 calculates similarity values between the image of the inserted coin C and the head and tail of the selected reference image, respectively (step S203). The similarity value is then compared with a critical value (step S204). If the similarity value is larger than the critical value, the process goes to step S205 indicating that the inserted coin C is genuine and the process ends. Otherwise, the process goes to step S206 for rotating the image of the inserted coin C by a predetermined angle. A determination result is made as to whether the accumulated rotation angle is larger than 360 degrees (step S207). If yes, it is determined that the inserted coin C is a counterfeit coin (step S208) and the process ends. Otherwise, the process loops back to step S203 for further similarity value calculation and comparison. Note that the predetermined angle is preferably a factor of 360 degrees. For example, the predetermined angle may be 30 degrees (i.e., the number of the rotation is 12), 36 degrees (i.e., the number of the rotation is 10), or 60 degrees (i.e., the number of the rotation is 6). In other words, a truth of the inserted coin C can be determined by, for example, at most 12 times of rotation if the predetermined angle is 30 degrees. The determined result of the inserted coin C is eventually sent to a distributor 17.

Moreover, for more precisely recognizing a truth of the inserted coin C, a second image sensor 12′ is provided at the other side of the coin receiving unit 11. The second image sensor 12′ may fetch an image of the other side of the inserted coin C which is already positioned in the coin receiving unit 11. Hence, the image recognition unit 13 may compare two images (e.g., head and tail images) of the inserted coin C with the selected reference images for recognition. This comparison is similar to the steps described with respect to FIG. 2, and thus a detailed description is deemed unnecessary. It is important to note that a truth of the inserted coin C can only be determined when both the head and the tail of the inserted coin C are genuine after being compared.

In the embodiment shown in FIG. 1, there is further provided a physical property detector 16 for measuring a physical property (e.g., weight or magnetic property) of the inserted coin C. Also, the measured result is sent to the distributor 17. The distributor 17 may then determine whether the image recognition result sent from the image recognition unit 13 and the result of the measured physical property sent from the physical property detector 16 are the same or not. A positive determination result will cause an acceptance of the inserted coin C by showing a value of the inserted coin C on an amount display of the vending machine or currency exchanger. On the contrary, a negative determination result will cause a rejection of the inserted coin C by returning it from a slot of the vending machine or currency exchanger.

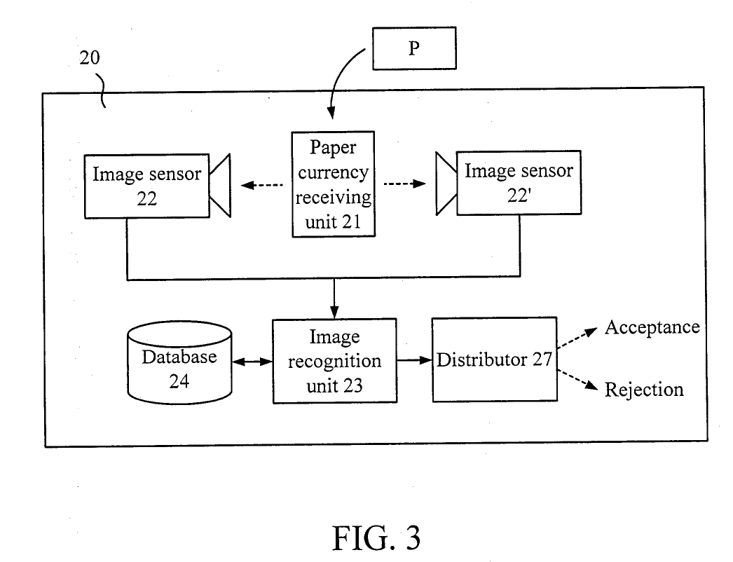

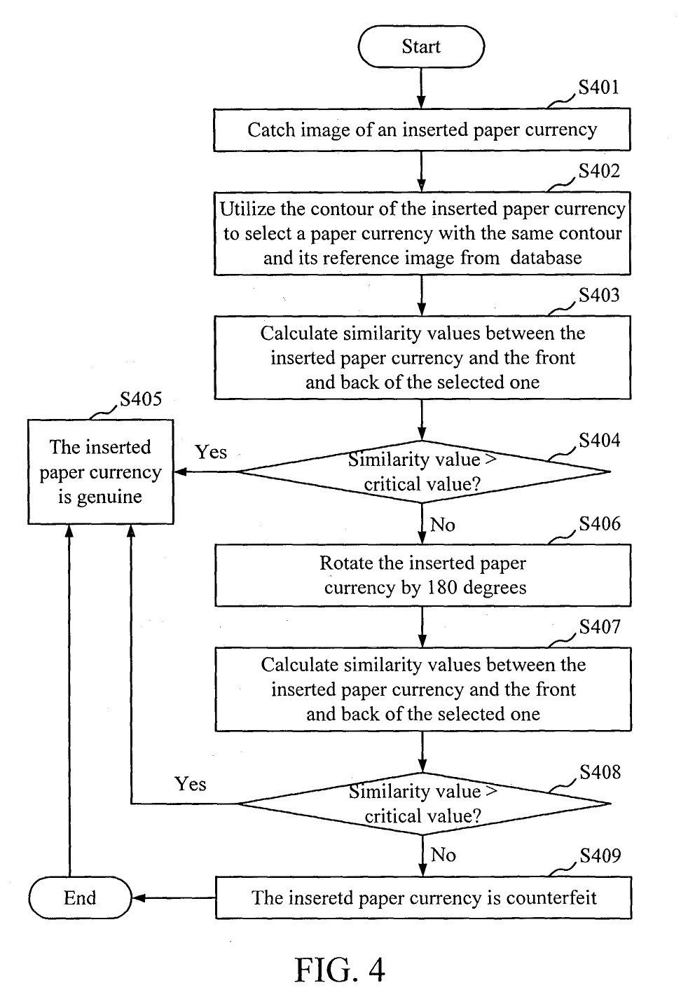

With reference to FIGS. 3 and 4, there is shown a second preferred embodiment of paper currency recognition apparatus mounted in a money-receiving machine 20 and a process of recognizing a paper currency in accordance with the invention respectively. The money-receiving machine 20 is also installed in a vending machine, currency exchanger, or any of other machines for paper currency recognition. The characteristics of two preferred embodiments are substantially the same. Hence, only the differences therebetween (i.e., the characteristics of the second preferred embodiment) will now be described in detail below.

A paper currency receiving unit 21 can receive and position an inserted paper currency P. An image sensor 22 at one side of the paper currency receiving unit 21 can catch an image of one side of the inserted paper currency P (step S401). A database 24 is stored with a plurality of reference images of both sides of a plurality of genuine paper currencies. Also, a second image sensor 22′ may be provided at the other side of the paper currency receiving unit 21 for fetching an image of the other side of the inserted paper currency P.

In addition, the image recognition unit 23 may utilize the character, for example, the money value shown on a corner of the inserted paper currency P, of the fetched image to select a paper currency with the same value and its reference image from a database 24 (step S402). This can significantly reduce workload of the coin recognition apparatus by screening out the paper currencies having unmatched values. Next, the image recognition unit 23 calculates similarity values between the image of the inserted paper currency P and the front and back of the selected reference image, respectively (step S403). The similarity value is then compared with a critical value (step S404). Note that, if further calculation and comparison are required, the fetched image of the inserted paper currency P is required to rotate 180 degrees only once since a paper currency is always of a rectangular shape. If the similarity value is larger than the critical value, the process goes to step S405 indicating that the inserted paper currency P is genuine and the process ends. Otherwise, the process goes to step S406 for rotating the image of the inserted paper currency P by 180 degrees. Next, the image recognition unit 23 calculates the similarity values between the rotated image of the inserted paper currency P and the reference images (step S407). The similarity value is then compared with the critical value again (step S408). If the similarity value is still larger than the critical value, the process goes to step S405. Otherwise, the process goes to step S409 indicating that the inserted paper currency P has been determined to be a counterfeit paper currency and the process ends. The determined result of the inserted paper currency P is eventually sent to a distributor 27 as a basis for accepting or rejecting the inserted paper currency P.

In view of the foregoing, it is known that, in addition to measuring the size, weight, and material property of a coin or paper currency, the present invention can ensure the true coin or paper currency by recognizing the pattern on the coin or paper currency, thereby increasing the accuracy of recognition. It is also noted that the number of candidate images of coins (or paper currencies) stored in the database may be updated based on the genuine currency issued by the government, thereby increasing the flexibility.

Although the present invention has been explained in relation to its preferred embodiment, it is to be understood that many other possible modifications and variations can be made without departing from the spirit and scope of the invention as hereinafter claimed.

What is claimed is:

1. A coin recognition apparatus mounted in a money-receiving machine, the money-receiving machine having a distributor and a coin receiving unit adapted for receiving and positioning an inserted coin to be recognized, said coin recognition apparatus comprising:
a database for storing a plurality of reference images including head and tail images of coins;
an image sensor disposed at a side of the coin receiving unit for fetching an image of the inserted coin; and
an image recognition unit for comparing the image of the inserted coin with the reference images from the database to generate a determination result for controlling the distributor to accept or reject the inserted coin.

2. The apparatus as claimed in claim 1, wherein the image recognition unit selects one of the reference images of the coins based on the contour of the image of the inserted coin.

3. The apparatus as claimed in claim 1, further comprising a contour detector for fetching the contour of the image of the inserted coin.

4. The apparatus as claimed in claim 1, wherein the image recognition unit is operative to rotate the image of the inserted coin by a predetermined angle, calculate a similarity value between the image of the inserted coin and the reference images of the coins, and determine that the inserted coin is genuine if the similarity value is larger than a critical value.

5. The apparatus as claimed in claim 1, further comprising a second image sensor disposed at the other side of the coin receiving unit for fetching an image of the other side of the inserted coin.

6. The apparatus as claimed in claim 5, wherein the image recognition unit selects the reference image of coins based on the contour of any one of the image of the inserted coin, and respectively compares the two images of the inserted coin with head or tail of the selected reference image from the database to generate a determination result.

7. A paper currency recognition apparatus mounted in a money-receiving machine, the money-receiving machine having a distributor and a paper currency receiving unit adapted for receiving and positioning an inserted paper currency, the paper currency recognition apparatus comprising:
a database for storing a plurality of reference images including front and back images of paper currencies;
an image sensor disposed at a side of the paper currency receiving unit for fetching an image of the inserted paper currency; and
an image recognition unit for comparing the image of the inserted paper currency with the reference images of paper currencies from the database to generate a determination result for controlling the distributor to accept or reject the inserted paper currency.

8. The apparatus as claimed in claim 7, wherein the image recognition unit selects the reference images of the currencies based on the character shown on the image of the inserted paper currency.

9. The apparatus as claimed in claim 7, wherein in response to that the image of the inserted paper currency does not correspond to the reference image of paper currency, the image recognition unit is operative to rotate the image of the inserted paper currency by 180 degrees to obtain a rotated image, and to compare the rotated image of the inserted paper currency with the reference image to generate a determination result.

10. The apparatus as claimed in claim 7, further comprising another image sensor disposed at the other side of the paper currency receiving unit for fetching an image of the other side of the inserted paper currency.

11. The apparatus as claimed in claim 10, wherein the image recognition unit selects the reference image of paper currency based on the character shown on any one of the images of the inserted paper currency, and respectively compares the two images of the inserted paper currency with front and back of the selected reference image from the database to generate a determination result.

12. A coin recognition method used in a coin recognition apparatus mounted in a money-receiving machine for recognizing an inserted coin, the money-receiving machine having a distributor and a coin receiving unit for receiving and positioning the inserted coin, the coin recognition apparatus having a database, an image sensor, and an image recognition unit, said coin recognition method comprising the steps of:
(a) fetching an image of the inserted coin by the image sensor;
(b) selecting the reference image of coin corresponding to the image of the inserted coin from the database based on the contour of the image of the inserted coin by the image recognition unit;
(c) calculating a similarity value between the image of the inserted coin and the selected reference image; comparing the similarity value with a critical value to determine whether the similarity value is larger than a critical value, and if yes, determining that the inserted coin is genuine, otherwise performing step (d); and
(d) rotating the image of the inserted coin by a predetermined angle; determining whether the rotated angle is larger than 360 degrees, and if yes, determining that the inserted coin is counterfeit, otherwise performing step (c).

13. The method as claimed in claim 12, wherein the coin recognition apparatus further comprises another image sensor disposed at the other side of the coin receiving unit for fetching an image of the other side of the inserted coin.

14. The method as claimed in claim 13, wherein in step (b), the image recognition unit selects the reference image of coins based on the contour of any one of the image of the inserted coin, and respectively compares the two images of the inserted coin with head or tail of the selected reference image from the database.

15. A paper currency recognition method used in a paper currency recognition apparatus mounted in a money-receiving machine for recognizing an inserted paper currency, the money-receiving machine having a distributor and a coin receiving unit for receiving and positioning the inserted paper currency, the paper currency recognition apparatus having a database, an image sensor, and an image recognition unit, the paper currency recognition method comprising the steps of:
(a) fetching an image of the inserted paper currency by the image sensor;
(b) selecting the reference image of paper currency corresponding to the image of the inserted paper currency from the database based on a character shown on the image of the inserted paper currency by the image recognition unit;
(c) calculating a similarity value between the image of the inserted paper currency and the reference image of paper currency; comparing the similarity value with a critical value for determining whether the similarity value is larger than a critical value, and if yes, determining that the inserted paper currency is genuine, otherwise performing step (d); and
(d) rotating the inserted paper currency by an angle of 180 degrees; calculating a similarity value between the rotated image of the inserted paper currency and the reference image of paper currency; comparing the similarity value with the critical value for determining whether the similarity value is larger than a critical value, and if yes, determining that the inserted paper currency is genuine, otherwise determining that the inserted paper currency is counterfeit.

16. The method as claimed in claim 15, wherein the paper currency recognition apparatus further comprises another image sensor disposed at the other side of the paper currency receiving unit for fetching an image of the other side of the inserted paper currency.

17. The method as claimed in claim 16, wherein in the step (b), wherein the image recognition unit selects the reference image of paper currency based on the character shown on any one of the images of the inserted paper currency, and respectively compares the two images of the inserted paper currency with front and back of the selected reference image from the database.
